(19) United States
(12) Patent Application Publication
(10) Pub. No.: US 2025/0128619 A1
(43) Pub. Date: Apr. 24, 2025

(54) UNDERGROUND HAUL TRUCK

(71) Applicant: Caterpillar Underground Mining Pty Ltd., South Burnie (AU)

(72) Inventors: Andrew Ellis Diecker, Shorewell Park (AU); Michael James Wolfert, Coes Creek (AU); Alexander Eli Dowling, Mt Hicks (AU)

(73) Assignee: Caterpillar Underground Mining Pty Ltd., South Burnie (AU)

(21) Appl. No.: 18/491,705

(22) Filed: Oct. 20, 2023

(51) Int. Cl. B60L 53/18; B60L 50/51; B60L 53/22

(52) U.S. Cl. CPC B60L 53/18; B60L 50/51; B60L 53/22; B60L 2210/10

(57) ABSTRACT

A work machine that is powered by batteries in a power unit uses a locally distributed electrical system and a locally distributed hydraulic system. A portion of power from the power unit is provided to an inverter installed in a front section of the work machine to power electrical equipment installed in the front section. Another portion of the power from the power unit is provided to an inverter installed in a rear section of the work machine to power electrical equipment installed in the rear section. Additionally, a hydraulic pump installed in the front section pressurizes hydraulic fluid in a front accumulator for use by hydraulic loads in the front section and a hydraulic pump installed in the rear section pressurizes the hydraulic fluid in a rear accumulator for use by hydraulic loads in the rear section.

### TECHNICAL FIELD

The present disclosure relates to an underground mining vehicle. More specifically, the present disclosure relates to a mining vehicle that is uses one or more batteries to power and move the vehicle.

### BACKGROUND

Heavy work machines, such as earth-moving vehicles or hauling trucks, require significant power to carry out their functions. The machines themselves can be of substantial weight, and their loads require large amounts of power to move. Diesel engines have been used to provide that power, but they can have disadvantages. However, the use of combustion engines in enclosed mining spaces can present several challenges. For example, the exhaust from combustion engines needs to be effectively removed from underground routes in order to maintain an atmosphere hospitable to workers and reduce the addition of pollutants into the ground and the atmosphere. Further, these machines are used to move large loads of material along underground and above-ground haul routes over large distances. Supplies of diesel fuel may be far away from such locations or not easily delivered to such locations.

Electrical power has been used to supplement or replace diesel engines in these mining machines. In some environments, the electrical power is delivered from one or more batteries. The batteries are used to provide power to various electrical equipment in the work machine. For example, the batteries can provide power to equipment such as, but not limited to, electric motors for rotating the work machine wheels, inverters for converting the battery power to various other forms of electrical power, electrical pumps, pumps for hydraulic systems, and the like. These batteries can be charged while installed on the machine if a suitable connection and power source are available. In other examples, the batteries can be swapped whereby a discharged battery is removed and a charged battery is installed.

### SUMMARY

In a first aspect of the presently disclosed subject matter, a work machine includes a front section comprising a power unit comprising a plurality of batteries configured to provide direct current electrical power to the work machine, a first inverter configured to convert a first portion of the direct current electrical power provided by the power unit through a front power cable into alternating current, a first axle comprising a first front wheel assembly comprising a first front electrical motor configured to rotate a first front wheel shaft upon receiving the alternating current from the first inverter, and a second front wheel assembly comprising a second front electrical motor configured to rotate a second front wheel shaft upon receiving the alternating current from the first inverter, a rear section comprising a second inverter configured to convert a second portion of the direct current electrical power provided by the power unit through a rear power cable into alternating current, a second axle comprising, a first rear wheel assembly comprising a first rear electrical motor configured to rotate a first rear wheel shaft upon receiving the alternating current from the second inverter, and a second rear wheel assembly comprising a second rear electrical motor configured to rotate a second rear wheel shaft upon receiving the alternating current from the second inverter, wherein the first front electrical motor, the second front electrical motor, the first rear electrical motor, and the second rear electrical motor are individually controlled, and an articulating connector that movably connects the front section to the rear section.

In an additional aspect of the presently disclosed subject matter, a locally distributed electrical system for use in a work machine includes a first inverter installed on a front section of the work machine, the first inverter configured to convert a first portion of direct current electrical power provided by a power unit through a front power cable into alternating current to power, a first front wheel assembly comprising a first front electrical motor configured to rotate a first front wheel shaft upon receiving the alternating current from the first inverter, and a second front wheel assembly comprising a second front electrical motor configured to rotate a second front wheel shaft upon receiving the alternating current from the first inverter, and a second inverter installed on a front section of the work machine, the second inverter configured to convert a second portion of the direct current electrical power provided by the power unit through a rear power cable into alternating current to power a first rear wheel assembly comprising a first rear electrical motor configured to rotate a first rear wheel shaft upon receiving the alternating current from the second inverter, and a second rear wheel assembly comprising a second rear electrical motor configured to rotate a second rear wheel shaft upon receiving the alternating current from the second inverter, wherein the first front electrical motor, the second front electrical motor, the first rear electrical motor, and the second rear electrical motor are individually controlled.

In a still further aspect of the presently disclosed subject matter, a locally distributed hydraulic system for use in a work machine includes a first hydraulic pump installed in a front section of the work machine, the first hydraulic pump configured to pump hydraulic fluid from a hydraulic tank into a front accumulator, pressurizing the hydraulic fluid in the front accumulator for use by hydraulic loads in the front section, and a second hydraulic pump installed in a rear section of the work machine, the second hydraulic pump configured to pump the hydraulic fluid from the hydraulic tank, through a hydraulic line, and into a rear accumulator, pressurizing the hydraulic fluid in the rear accumulator for use by hydraulic loads in the rear section.

### BRIEF DESCRIPTION OF DRAWINGS

FIG. 1 illustrates an isometric view of a work machine within an XYZ coordinate system as one example suitable for carrying out the principles discussed in the present disclosure.

FIG. 2 is a top-down illustration of a work machine, in accordance with one or more examples of the present disclosure.

FIG. 3 illustrates the process of installing a power unit onto a work machine, in accordance with one or more examples of the present disclosure.

FIG. 4 is an illustration showing a lift mechanism used to mechanically engage a power unit with a work machine, in accordance with one or more examples of the present disclosure.

FIG. 5 is an illustration showing a power interface of a work machine, in accordance with one or more examples of the present disclosure.

FIG. 6 is an illustration showing a power unit interface of a power unit used to electrically connect the power unit with a work machine, in accordance with one or more examples of the present disclosure.

FIG. 7 is an illustration showing a rear axle in a rear section of a work machine, in accordance with one or more examples of the present disclosure.

FIG. 8 is an illustration showing an articulating connector that movably connects a front section to a rear section of a work machine, in accordance with one or more examples of the present disclosure.

FIG. 9 is a schematic of an energy transfer system used to power the work machine, in accordance with one or more examples of the presently disclosed subject matter.

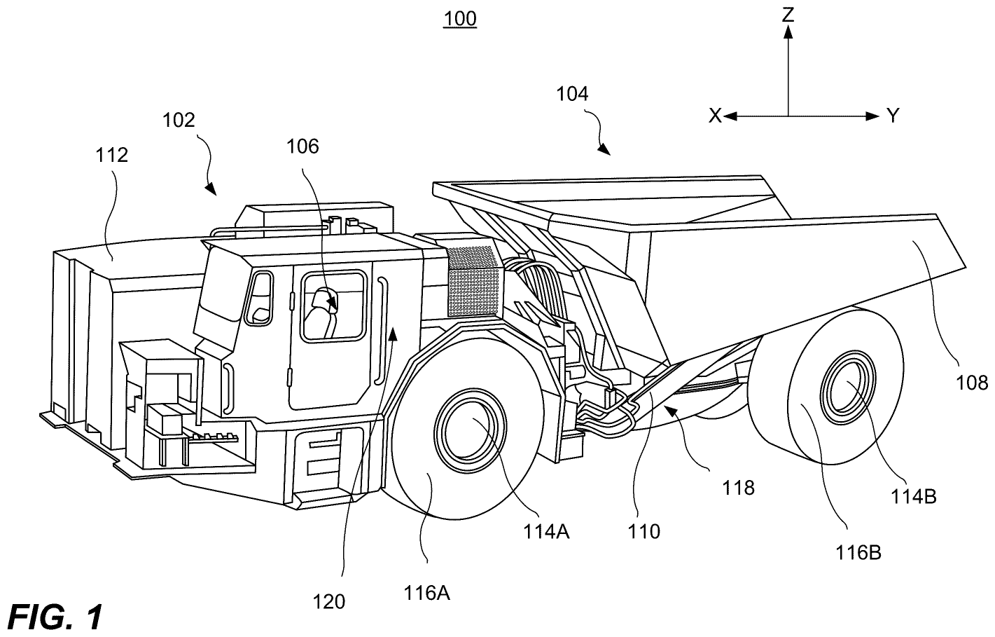

### DETAILED DESCRIPTION

Wherever possible, the same reference numbers will be used throughout the drawings to refer to same or like parts. FIG. 1 illustrates an isometric view of a work machine 100 within an XYZ coordinate system as one example suitable for carrying out the principles discussed in the present disclosure. The exemplary work machine 100 travels parallel to the X axis along a mining route, also termed a haul route 101, typically from a source to a destination within a worksite. In one implementation as illustrated, work machine 100 is a hauling machine that hauls a load within or from a worksite within an underground mining operation. For instance, the work machine 100 can haul excavated ore or other earthen materials from an excavation area along haul route 101 to dump sites and then return to the excavation area. In this arrangement, the work machine 100 is one of many similar machines configured to ferry earthen material in a trolley arrangement.

While a large, underground mining truck in this instance, the work machine 100 is any machine that carries a load between different locations within a worksite, examples of which include an articulated truck, an off-highway truck, an on-highway dump truck, a wheel tractor scraper, or any other similar machine. Alternatively, the work machine 100 is an off-highway truck, on-highway truck, a dump truck, an articulated truck, a loader, an excavator, a pipe layer, or a motor grader. In other implementations, the work machine 100 need not haul a load and can be any machine associated with various industrial applications including, but not limited to, mining, agriculture, forestry, construction, and other industrial applications.

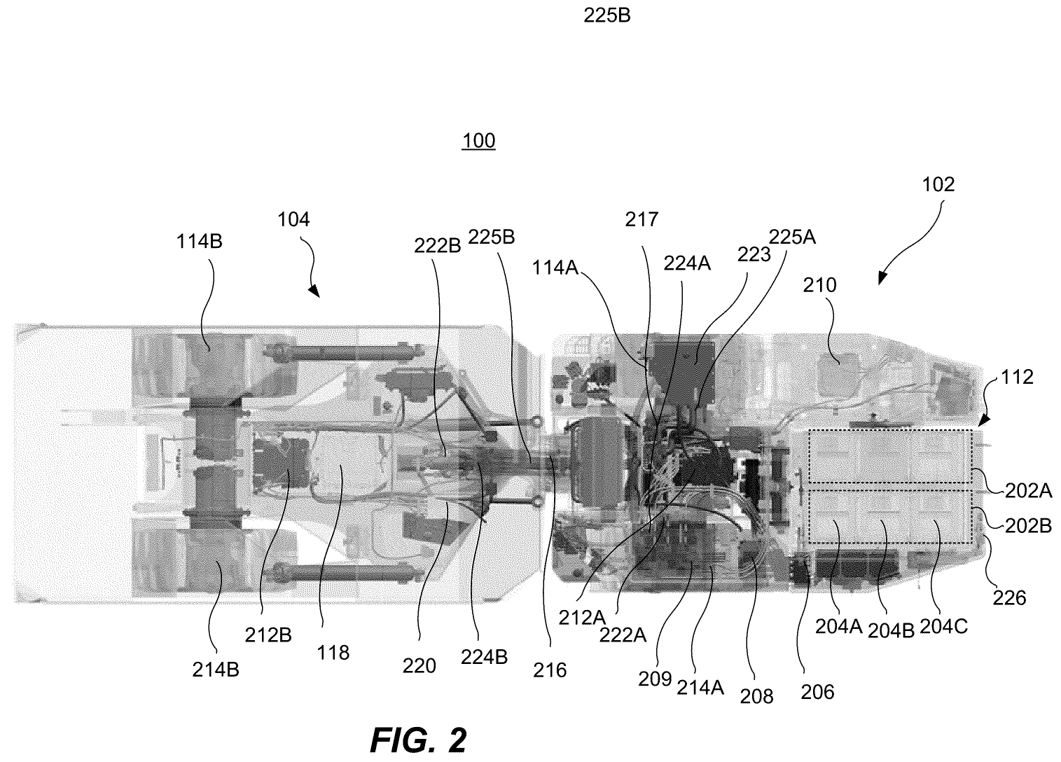

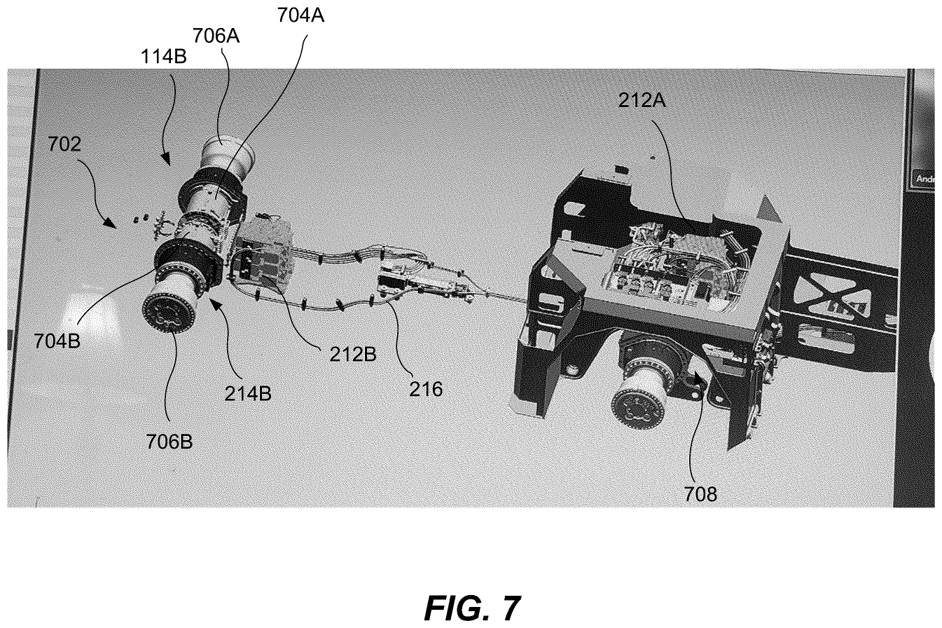

Referring to FIG. 1, an example work machine 100 includes a front section 102 and a rear section 104. In some examples, the front section 102 is movably connected to the rear section through an articulating connector, not shown, but illustrated in more detail in FIG. 2, below: In some examples, the front section 102 and the rear section 104 are independently movable in multiple axis of rotation, allowing the front section 102 a degree of movement independent of the rear section 104, explained in more detail in FIG. 7, below. The work machine 100 further includes a cab 106. The cab 106 can be a climate-controlled, interior space in which one or more operators of the work machine 100 occupies during the operation of the work machine 100. The work machine further includes a bucket 108 installed at the rear section 104 of the work machine 100. The bucket 108 is used as the volume in which mined material or other material may be placed for transport along the haul route 101. The bucket 108 is raised and lowered using hydraulic pistons, an example of which is illustrated in FIG. 1 as piston 110.

The work machine 100 further includes a power unit 112 that provides power to various electrical equipment of the work machine 100. The power unit 112 houses one or more set or assemblies of batteries (not illustrated), described in more detail in FIG. 2, below. The power unit 112 provides electrical power to wheel assemblies, such as a front wheel assembly 114A and a rear wheel assembly 114B, with complimentary wheel assemblies on the other side of the work machine 100 not shown. The wheel assemblies 114A and 114B are comprised of electrical motors that receive power from the power unit 112 through one or more inverters, described in more detail in FIG. 2. The inverters convert the direct current power provided by the batteries in the power unit 112 into alternating current used by the electrical motors of the wheel assemblies 114A and 114B. The polarity and power provided by the inverters to the wheel assemblies 114A and 114B causes the electrical motors of the wheel assemblies 114A and 114B to rotate, thereby rotating tires 116A and 116B respectively. In some examples, the wheel assemblies 114A and 114B receive power independently. For example, the wheel assembly 114A receives power from an inverter located in the front section 102, while the wheel assembly 114B receives power from an inverter located in the rear section 104. Additionally, as described in more detail in FIG. 7, a wheel assembly in one section, such as the front section 102 or the rear section 104, is powered independently of the complimentary wheel section in the same section. In this manner, each wheel assembly is operated independently of each other.

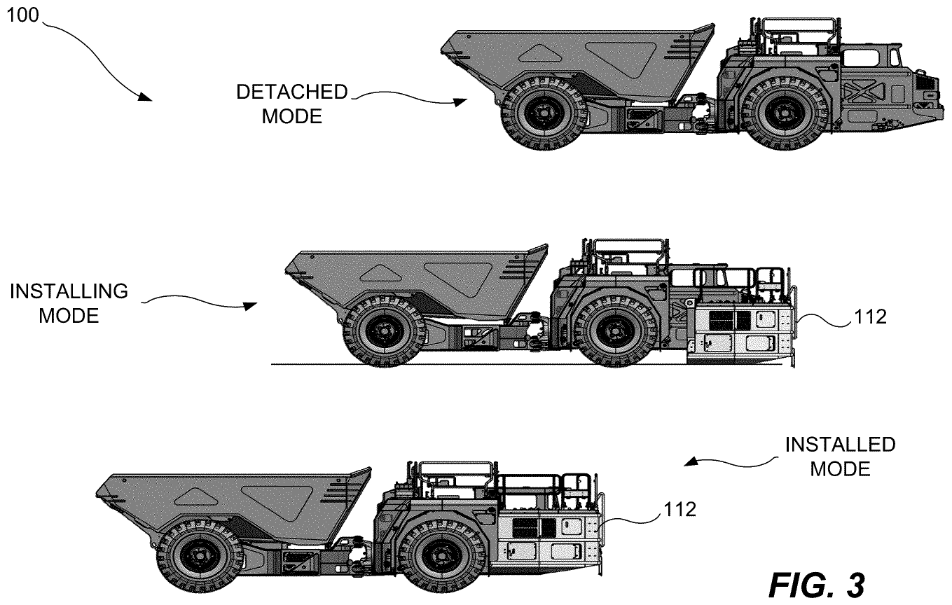

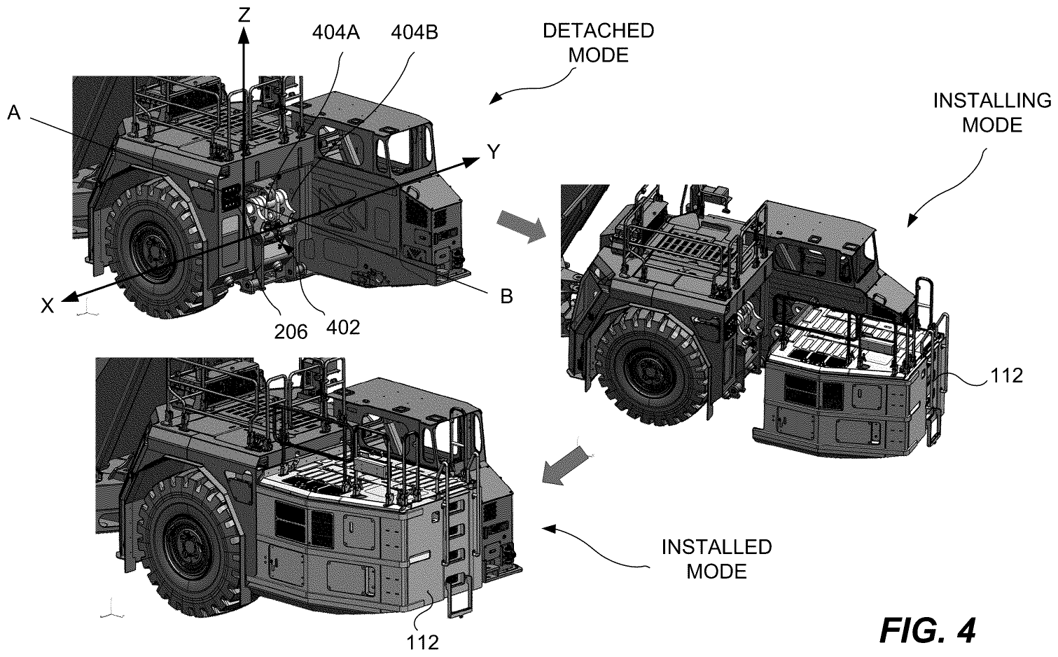

In some examples, the power unit 112 is unavailable for use. For example, as described in more detail in FIGS. 3 and 4, below; in some configurations of the work machine 100, the power unit 112 is removable. In other examples, the power unit 112 is discharged to a degree that the power unit 112 cannot provide power at a required level. Another example is a situation in which the power unit 112 is damaged or otherwise electrically disconnected from the work machine 100. In these examples during which the power unit 112 is unavailable for use, a secondary battery 118 is used. In some examples, the secondary battery 118 is used to move the work machine 100 along the haul route 101 by providing electrical power to one or more wheel assemblies 114A and 114B. In still further examples, the secondary battery 118 provides power to other electrical loads, such as, but not limited to, a heating, cooling and ventilation (HVAC) system 120. The HVAC system 120 is used to heat or cool air within the cab 106. In some examples, the secondary battery 118 is used to supplement or augment electrical power provided by the power unit 112 in certain conditions, such as when the power unit 112 is fully discharged and is being changed out for a fully charged the power unit 112. Additional electrical and mechanical systems powered by the power unit 112 and/or the secondary battery are illustrated in FIG. 2, below.

FIG. 2 is a top-down illustration of the work machine 100, in accordance with one or more examples of the present disclosure. As described above, electrical power to the work machine 100 is provided primarily by the power unit 112. The power unit 112 includes one or more batteries mechanically separated into one or more battery banks, illustrated as battery bank 202A and battery bank 202B. The battery bank 202A and the battery bank 202B include one or more batteries, illustrated by way of example as battery 204A, 204B, and 204C (referred to hereinafter individually as “the battery 204A,” “the battery 204B,” and “the battery 204C,” and collectively as “the batteries 204”). In some examples, the power unit 112 includes other systems used to monitor, control the temperature of, and control various functions of the power unit 112 not described herein. The batteries 204, in some examples, collectively provide relatively high direct current potential.

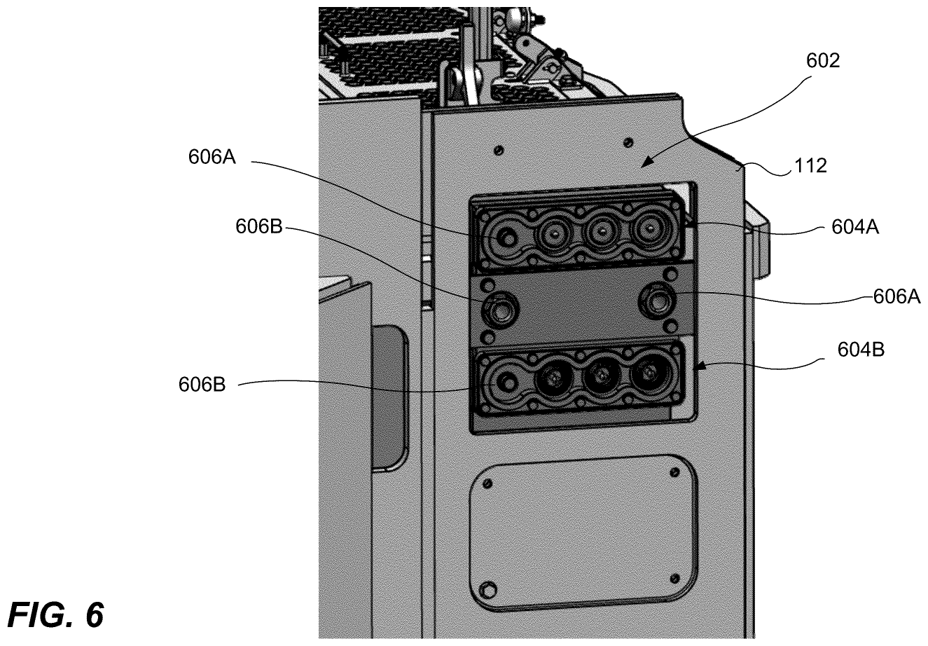

Electrical power from the power unit 112 is delivered to various equipment through power interface 206. The power interface 206 includes electrical connectors to connect the power unit 112 to various systems of the work machine 100 not included as a component of the power unit 112. An example of the power interface 206 is described in more detail in FIGS. 6 and 7. An example of equipment powered by the power unit 112 is equipment that requires a voltage lower than the voltage output of the power unit 112. In these examples, a low voltage converter 208 is provided. In some examples, the low voltage converter 208 steps down the voltage of the power unit 112 to a lower voltage, such as, but not limited to, 24V. A low voltage battery 210 is used to store power generated by the low voltage converter 208 as well as act as a battery for equipment operating at the lower voltage. The electrical power provided by the low voltage converter 208 is distributed using a power distribution unit 209. In some examples, the power distribution unit 209 receives power from the low voltage converter 208 and distributes that power to the equipment operating at the lower voltage. It should be noted that, as with other equipment described herein, more than one low voltage converter and low voltage battery can be used, including those at different voltages than the low voltage converter 208.

The power unit 112 can also provide power to equipment that uses alternating current rather than a direct current. In these examples, a front inverter 212A and a rear inverter 212B are provided. The front inverter 212A and the rear inverter 212B receive the power from the power unit 112 and converts the direct current/voltage provided by the power unit 112 to an alternating current/voltage used by various equipment. For example, as discussed in FIG. 1, each wheel assembly of the work machine are individually controllable. Illustrated in FIG. 2 are the wheel assembly 114B introduced in FIG. 1 and wheel assembly 214B. The wheel assemblies are comprised of an electrical motor that use AC power to cause the rotation of a shaft (not shown) of the electrical motor of the wheel assemblies 114B and 214B. The rear inverter 212B receives power (i.e., is in electrical communication with) from the power unit 112 through rear power cable 216. The front inverter 212A receives power from the power unit 112 through front power cable 217. The rear inverter 212B converts the electrical power from the power unit 112 and delivers the AC power to each of the wheel assemblies 114B and 214B, whereby the power delivered to each of the wheel assemblies 114B and 214B may be different as to each other and may be different as to wheel assemblies located in the front section 102, such as the wheel assembly 114A introduced in FIG. 1. In a similar manner, the front inverter 212A converts the electrical power from the power unit 112 and delivers the AC power to each of the wheel assemblies 114A and 214A, whereby the power delivered to each of the wheel assemblies 114A and 214A may be different as to each other and may be different as to wheel assemblies located in the rear section 104, such as the wheel assemblies 114B and 214B. In some examples described herein, the electrical power is a locally distributed power system whereby the front inverter 212A provides electrical power to equipment in the front section 102 and the rear inverter 212B provides electrical power to equipment in the rear section 104. Thus, the electrical power provided by the front inverter 212A and the rear inverter 212B is a locally distributed power system, meaning components receiving power from an inverter receives the power from an inverter located in the same section that the component is located. Thus, in some examples only a single power cable from the front section 102 to the rear section 104 from the power unit 112, i.e., the rear power cable 216, is used to provide power to the rear section 104 components rather than individual power cables to each of the components. It should be noted that in some configurations, the wheel assemblies disclosed herein are configured to use alternating current or direct current. As such, the presently disclosed subject matter is not limited to either direct current or alternating current. Further, in those configurations, the front inverter 212A and/or the rear inverter 212B may be configured to provide or supply direct current power and alternating current power.

In addition to the low voltage battery 210, as described in FIG. 1, in some examples, the secondary battery 118 is used to power equipment requiring a higher voltage than what may be provided by the low voltage battery 210. In the example in which the power unit 112 is unavailable for use, the secondary battery 118 is used to provide power to the front and rear wheel assemblies, such as the wheel assemblies 114B and 214B, as well as the wheel assemblies 114A and a wheel assembly 214A. In the examples in which the secondary battery 118 is being used as the primary power source, power from the secondary battery 118 may be transmitted to the rear inverter 212B and/or the front inverter 212A to provide AC power to components powered by the rear inverter 212B and/or the front inverter 212A. In some examples, DC power provided by the secondary battery 118 is increased in voltage using a converter 220) (sometimes referred to as a “buck booster,” “buck boost inductor,” or “buck boost converter”). The converter 220 in some examples is a direct current to direct current converter that outputs a direct current voltage greater than the input voltage. In some examples, the higher voltage output of the converter 220 is received as a power input to the rear inverter 212B and/or the front inverter 212A to provide AC power to components powered by the rear inverter 212B and/or the front inverter 212A. In some examples, the converter 220 can receive power from the power unit 112 through rear power cable 216 to charge the secondary battery 118.

The work machine 100 further includes a locally distributed hydraulic system that provides hydraulic power hydraulic equipment used by the work machine 100. In FIG. 2, the work machine includes a front hydraulic pump 222A and a rear hydraulic pump 222B. The front hydraulic pump 222A is an electrical pump that receives a hydraulic fluid stored in a hydraulic tank 223 through hydraulic line 225A and pressurizes the hydraulic fluid for use by a front accumulator 224A. Similarly, the rear hydraulic pump 222B is an electrical pump that receives the hydraulic fluid stored in the hydraulic tank 223 through hydraulic line 225B and pressurizes the hydraulic fluid for use by a rear accumulator 224B. In a manner similar to the front inverter 212A and the rear inverter 212B, the front accumulator 224A is used to provide hydraulic pressure to hydraulic loads in the front section 102 and the rear accumulator 224B is used to provide hydraulic pressure to hydraulic loads in the rear section 104. In some examples, the hydraulic lines 225A and 225B are a relatively lower pressure hydraulic line. In this configuration, the hydraulic line from the front section 102 to the rear section 104, i.e., the hydraulic line 225B, is a lower pressure line.

In some examples, the work machine 100 has a first configuration in which the power unit 112 is removably affixed to the work machine 100. In the first configuration, the power unit 112 is charged by an external power source through a charging port 226 located on the work machine 100. Although in the first configuration the power unit 112 can be removed in certain instances such as during maintenance, the power unit 112 and the work machine 100 are configured to be primarily a combined, single unit during the use of the work machine 100. A cable (not shown) from the external power source is mechanically and electrically attached to the charging port 226. Electrical power is then transferred through the charging port 226 into the batteries 204 of the power unit 112 to recharge the batteries 204. When using the first configuration, because the power unit 112 remains electrically and mechanically connected to the work machine 100, some components described in FIG. 2 may not be needed. For example, the secondary battery 118, the power interface 206, and the converter 220 may not be required or desired in the first configuration. It should be understood, however, one or more of the aforementioned components, and other components not mentioned, may still be installed regardless of the configuration of the work machine 100. The work machine 100 may also have a second configuration in which the power unit 112 is removed and replaced with a second power unit. In the second configuration, when a new power unit 112 is to be used, the work machine 100 and the power unit 112 are configured to allow the power unit 112 to be removed from the work machine 100, after which a new, charged power unit 112 is installed onto the work machine, illustrated in more detail in FIGS. 3 and 4.

FIG. 3 illustrates the process of installing the power unit 112 onto the work machine in the second configuration of the work machine 100, in accordance with one or more examples of the present disclosure. Illustrated in FIG. 3 are a detached mode, an installing mode, and an installed mode of the work machine 100 in relation to the installation status of the power unit 112. In the detached mode, the work machine 100 is not engaged with a power unit. An example of the detached mode may include, but is not limited to, a period in which maintenance is being performed on the work machine 100 and no power unit 112 is needed. Another example of the detached mode may be when the work machine 100 has previously detached a power unit and is moving to another location to receive a new power unit. The installing mode represents the configuration in which the work machine 100 is moving or has moved to a location suitable to engage and receive the power unit 112. The installed mode represents the configuration in which the work machine 100 has received the power unit 112 and have mechanically and electrically connected the power unit 112 to the work machine 100 using a lift mechanism and the power interface 206, illustrated in additional detail in FIG. 4.

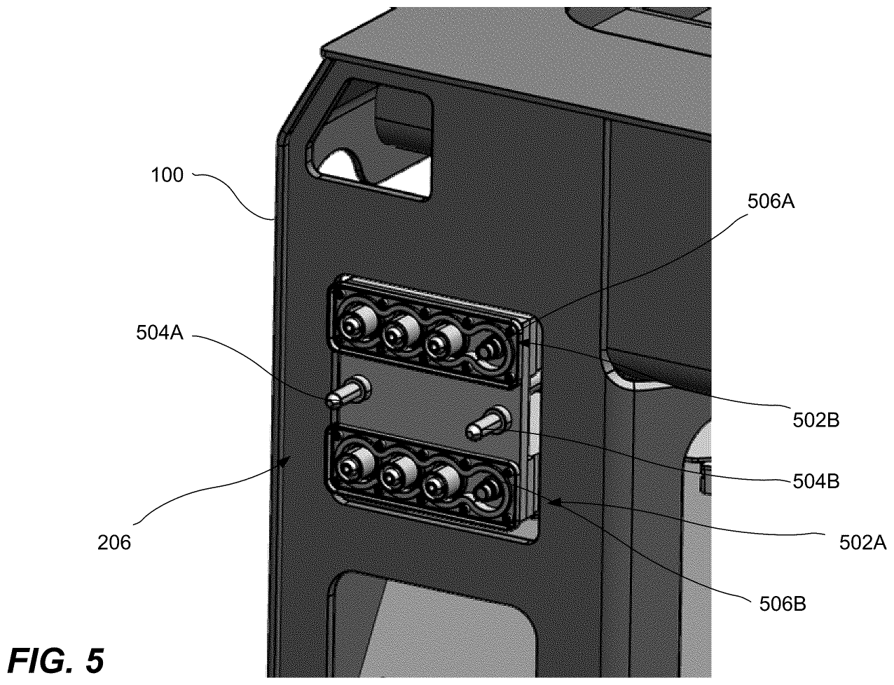

FIG. 4 is an illustration showing a lift mechanism 402 used to mechanically engage the power unit 112 with the work machine 100 and the power interface 206 used to electrically engage and disengage the power unit 112 to and from the work machine 100, in accordance with one or more examples of the present disclosure. FIG. 4 shows the detached mode, the installing mode, and the installed mode of the work machine 100. To mechanically engage the power unit 112 with the work machine 100, the lift mechanism 402 is provided. The lift mechanism 402 rotates about an axis XY, whereby the axis XY is normal to a centerline AB of the work machine 100. Lifter arms 404A and 404B engage with the power unit 112. When rotated about the axis XY, the lifter arms 404A and 404B move in the direction Z, lifting the power unit 112 off the ground and engaging the power unit 112 with the work machine 100. The lifter arms 404A and 404B are rotated using hydraulic power or electrical power. When the lifter arms 404A and 404B rotate to engage the power unit 112 with the work machine 100, electrical connections from the power unit are proved through the power interface 206 located on the work machine 100, described in additional detail in FIG. 5.

FIG. 5 is an illustration showing the power interface 206 of the work machine 100, in accordance with one or more examples of the present disclosure. The power interface 206 includes male connectors 502A and 502B. The male connectors 502A and 502B extend a distance out from the work machine 100 to engage with complimentary female connectors, illustrated in FIG. 6. The power interface 206 further includes alignment pins 504A and 504B that also extend a distance out from the work machine 100 and engage with complementary female alignment holes shown in FIG. 6. The alignment pins 504A and 504B act as an indicator that the power unit 112, when lifted into the installed mode of FIGS. 3 and 4, is properly aligned and positioned onto the work machine 100. The male connectors 502A and 502B are electrically connected with various systems and are designed to receive various electrical inputs. For example, power connector 506A are configured to receive electrical power from the battery bank 202A and power connector 506B are configured to receive electrical power from the battery bank 202B. In some configurations, the battery bank 202A and the battery bank 202B are electrically connected so that the power from both the battery bank 202A and the battery bank 202B is provided through a single positive terminal and a single negative terminal. Thus, in this configuration, the power connector 506A are configured to receive electrical power from the positive terminal of the battery banks 202A and 202B and the power connector 506B are configured to connect to the negative or ground terminal of the battery banks 202A and 202B. The male connectors 502A and 502B may provide an electrical connection for other electrical signals such as data, communication systems, additional power systems, sensors, and the like.

FIG. 6 is an illustration showing a power unit interface 602 of the power unit 112 used to electrically connect the power unit 112 with the work machine 100, in accordance with one or more examples of the present disclosure. The power unit interface 602 includes female recesses 604A and 604B. The female recesses 604A and 604B extend a distance into the work machine 100 to receive the complementary male connectors 502A and 502B of the power interface 206 that are inserted into complementary female recesses 604A and 604B. The power unit interface 602 further includes alignment recesses 606A and 606B that receive the alignment pins 504A and 504B. The female power connector 608A receives the power connector 506A and the female power connector 608B receives the power connector 508B to be distributed to various systems, including locally distributed systems such as the wheel assemblies 114A, 114B, 214A, and 214B, illustrated in FIG. 7.

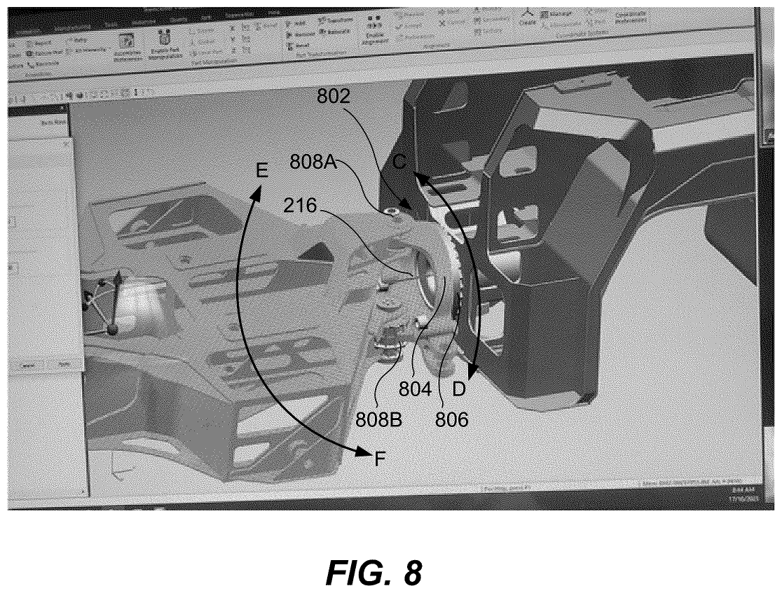

FIG. 7 is an illustration showing a rear axle 702 in the rear section 104 of the work machine 100 of FIG. 1, in accordance with one or more examples of the present disclosure. The rear axle 702 includes the wheel assemblies 114B and 214B. The wheel assembly 114B includes a rear electrical motor, an electrical motor 704A, and the wheel assembly 214B includes electrical motor 704B. Front electrical motors similarly configured as the rear electrical motors 704A and 704B are included on the front axle 708. A rear wheel shaft 706A of the wheel assembly 114B rotates when sufficient power is received by the electrical motor 704A from the rear inverter 212B. Similarly, a rear wheel shaft 706B of the wheel assembly 214B rotates when sufficient power is received by the electrical motor 704B from the rear inverter 212B. The rotation of the wheel shaft 706A and/or the wheel shaft 706B rotates their respective tires affixed to the wheel shafts 706A and/or 706B. The front axle 708 in the front section 102 of the work machine 100 of FIG. 1 is similarly configured using the front inverter 212A to rotate front electrical motors and front wheel shafts. Electrical power from the power unit 112 to the rear inverter 212B is delivered through the rear power cable 216. In some examples, as discussed above, the rear power cable 216 are routed within an articulating connector, illustrated in FIG. 8.

FIG. 8 is an illustration showing an articulating connector 802 that movably connects the front section 102 to the rear section 104 of the work machine 100, in accordance with one or more examples of the present disclosure. As used herein, “movably connects” means that the front section 102 and rear section 104 have at least one degree of freedom of movement relative to each other. When the work machine 100 moves along haul route 101, the front section 102 and the rear section 104 can experience different forces, causing the rear section 104 to move in different directions than the front section 102. To provide a degree of freedom of movement while still maintaining a mechanical connection, the articulating connector 802 provides for multiple degrees of freedom of movement and rotation. For example, to provide a rotational degree of freedom, a connector collar 804 of the articulating connector 802 is rotatably affixed to rotating collar 806 of the front section 102. The rotating collar 806 can include bearings or other assemblies that allow the rear section 104 and the front section 102 to rotate independent of each other about roll arc CD. To provide for a yawing motion of the rear section 104 with respect to the front section 102, the rear section 104 is attached to the articulating connector 802 by pin connectors 808A and 808B. The pin connectors 808A and 808B allow the rear section 104 to yaw (or move about yaw arc EF) in relation to the front section 102. The rear power cable 216 is routed through the articulating connector 802, which minimizes the movement of the rear power cable 216 when the rear section 104 moves independently of the front section 102. The hydraulic line 225B is similarly routed through the articulating connector 802, helping to minimize the movement of the hydraulic line 225B when the rear section 104 moves independently of the front section 102.

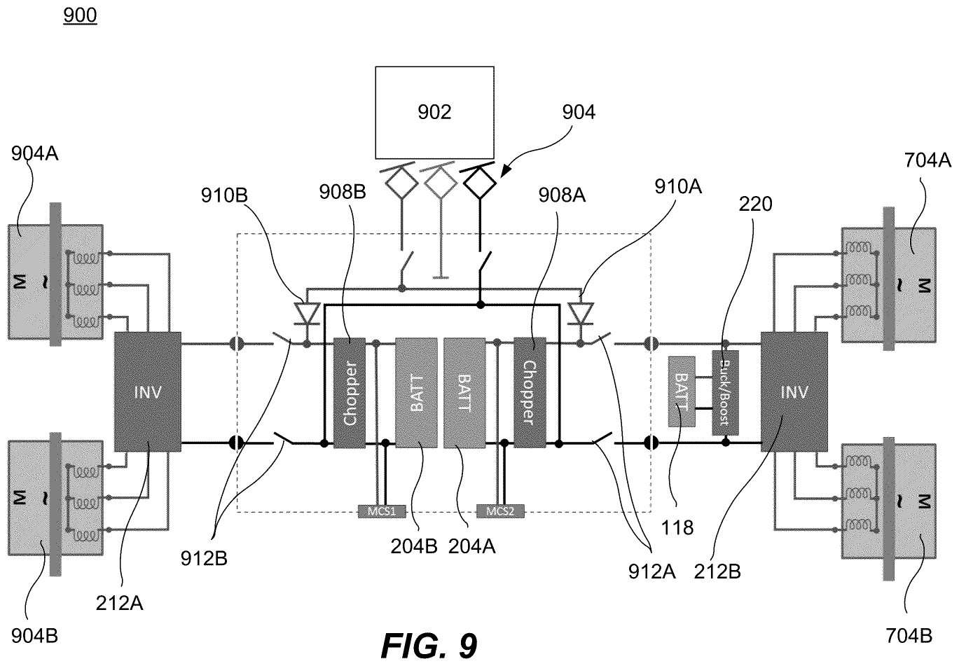

FIG. 9 is an electrical diagram illustrating a charging system 900 that may be used to charge the batteries 204A and 204B while the work machine 100 is moving, in accordance with one or more examples of the present disclosure. In some examples of use, the work machine 100 may be proximate to a power source 902. The power source 902 may be a power source that delivers power into power conduits 904 of the work machine 100. For example, the power source 902 and the power conduits 904 are a pantograph assembly with power lines that extend a distance along the path of the work machine 100. Power received from the power source 902 is provided to a first chopper inverter 908A and a second chopper inverter 908B. The first chopper inverter 908A converts the power received from the power source 902 though diode 910A to charge the battery 204A. Similarly, the second chopper inverter 908B converts the power received from the power source 902 through diode 910B to charge the battery 204B. It should be noted that the diodes 910A and 910B may not be required for use in a single direct current bus system, the charging system of 900 illustrating a split direct current bus. In still further examples, when connected to the power source 902, power may be provided directly to the front inverter 212A and the rear inverter 212B through the chopper inverters 908A and 908B. The batteries 204A and 204B may be disconnected from the rear inverter 212B by opening contacts 912A and from the front inverter 212A by opening contacts 912B. During use, the contacts 912A and 912B are closed to allow the batteries 204A and 204B to be charged while providing electrical power to the front inverter 212A and the rear inverter 212B. It should be noted that in some configurations, the charging system 900 may provide power directly to the wheel motors 704A/B and 904A/B while charging the batteries 204A/B.

### INDUSTRIAL APPLICABILITY

The work machine 100 described herein uses a locally distributed electrical system and hydraulic system. Power from the power unit 112 is provided to the front inverter 212A. The front inverter 212A provides power to electrical systems located in the front section 102 of the work machine 100. Similarly, power from the power unit 112 is provided to the rear inverter 212B. The rear inverter 212B provides power to electrical systems located in the rear section 104 of the work machine 100. The power from the power unit 112 to the rear inverter 212B is provide through the rear power cable 216, which is routed through the articulating connector 802, which minimizes the movement of the rear power cable 216 when the rear section 104 moves independently of the front section 102. The hydraulic line 225B is similarly routed through the articulating connector 802, helping to minimize the movement of the hydraulic line 225B when the rear section 104 moves independently of the front section 102. Reducing the movement of the rear power cable 216 and the hydraulic line 225B when the work machine 100 is moving can reduce wear and tear on the rear power cable 216 and the hydraulic line 225B, thereby reducing the probability of either the rear power cable 216 or the hydraulic line 225B failing. This can increase the reliability of the work machine 100.

The reliability and performance of the work machine 100 is further increased using independently controllable wheel assemblies. For example, the rear axle 702 includes the wheel assemblies 114B and 214B. The wheel assembly 114B includes electrical motor 704A and the wheel assembly 214B includes electrical motor 704B. The electrical motors 704A and 704B can be separately controlled, allowing for an increased degree of movement by allowing the tires to spin at different rotational speeds and potentially different rotational directions. Further, as described above, the work machine 100 may be used for underground mining operations. Some underground mining operations have significant space constraints that limit the height and width of the work machine 100, thus limiting the size of the inverter used to provide the AC power to the electrical motors. In a mining operation, this reduction in speed can result in lost revenue because the work machine 100 may take longer to move along the haul route 101. However, in the configurations described in the presently disclosed subject matter, the power provided to each of the wheel assemblies is provided by an inverter located proximate to the wheel assemblies. Whereby before a single inverter may be limited in the amount of power deliverable to an electric motor, constrained by the space in the underground mine, examples of the presently disclosed subject matter place the inverter proximate to and in the same section as the load powered by the inverter. This reduces the resistive losses incurred as compared to a single, larger inverter, thus providing more power (i.e., “torque to ground”) to the wheel assemblies, resulting in a potentially higher speed available for use.

Additionally, the batteries of the power unit 112 may be charged while the work machine 100 is moving through the use of the charging system 900. The charging system 900 include the power source 902 that is accessible electrically and mechanically by the power conduits 904 of the work machine 100. For example, the power source 902 and the power conduits 904 are a pantograph assembly with power lines that extend a distance along the path of the work machine 100. The use of the charging system 900 provides for the continued use and charging of the power unit 112. Additionally, as discussed above, the charging system 900 may be configured to connect the external power source 902 directly to the front inverter 912 and/or the rear inverter 212B via chopper inverters 908A and 908B, bypassing the power unit. 912. In some examples, the direct connection will allow for higher power draw from the power source 902 to achieve more torque for the motors 704A/B and 904A/B. Further, in some examples, the direct connection provides for the ability to take the batteries offline when the batteries have reached maximum state of charge.

Unless explicitly excluded, the use of the singular to describe a component, structure, or operation does not exclude the use of plural such components, structures, or operations or their equivalents. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A work machine, comprising:
a front section comprising:
a power unit comprising a plurality of batteries configured to provide direct current electrical power to the work machine;
a first inverter configured to convert a first portion of the direct current electrical power provided by the power unit through a front power cable into alternating current;
a first axle comprising:
a first front wheel assembly comprising a first front electrical motor configured to rotate a first front wheel shaft upon receiving the alternating current from the first inverter; and
a second front wheel assembly comprising a second front electrical motor configured to rotate a second front wheel shaft upon receiving the alternating current from the first inverter;
a rear section comprising:
a second inverter configured to convert a second portion of the direct current electrical power provided by the power unit through a rear power cable into alternating current;
a second axle comprising:
a first rear wheel assembly comprising a first rear electrical motor configured to rotate a first rear wheel shaft upon receiving the alternating current from the second inverter; and
a second rear wheel assembly comprising a second rear electrical motor configured to rotate a second rear wheel shaft upon receiving the alternating current from the second inverter, wherein the first front electrical motor, the second front electrical motor, the first rear electrical motor, and the second rear electrical motor are individually controlled; and
an articulating connector that movably connects the front section to the rear section.

2. The work machine of claim 1, wherein the articulating connector comprises a rotating collar configured to allow the rear section to rotate about a roll arc independently of the front section.

3. The work machine of claim 2, wherein the articulating connector further comprises at least one pin connector configured to allow the rear section to yaw about a yaw arc in relation to the front section.

4. The work machine of claim 1, wherein the rear power cable is routed through the articulating connector.

5. The work machine of claim 1, wherein the power unit is removably affixed in a first configuration, wherein the plurality of batteries of the power unit are charged from power received through a charging port.

6. The work machine of claim 1, wherein in a second mode the power unit is a first power unit that is replaceable by a second power unit, and wherein the first power unit is removed from the front section by lowering a lift mechanism on the front section and the second power unit is installed onto the front section by lifting the lift mechanism on the front section.

7. The work machine of claim 6, wherein the rear section further comprises a secondary battery that provides electrical power to the work machine while the first power unit and the second power unit are electrically disconnected from the work machine.

8. The work machine of claim 7, wherein the secondary battery is configured to provide power to the first front wheel assembly, the second front wheel assembly, the first rear wheel assembly, and the second rear wheel assembly to move the work machine while the first power unit and the second power unit are electrically disconnected from the work machine.

9. The work machine of claim 6, further comprising a power interface installed on the front section of the work machine and a power unit interface installed on the power unit, wherein the power interface comprises a plurality of male connectors and the power unit interface comprises a plurality of female recesses, wherein the male connectors are configured to insert into complementary female recesses to electrically connect the power unit to the work machine.

10. The work machine of claim 1, further comprising:
a first hydraulic pump installed in the front section, the first hydraulic pump configured to pump hydraulic fluid from a hydraulic tank into a front accumulator, pressurizing the hydraulic fluid in the front accumulator for use by hydraulic loads in the front section; and
a second hydraulic pump installed in the rear section, the second hydraulic pump configured to pump the hydraulic fluid from the hydraulic tank, through a hydraulic line, and into a rear accumulator, pressurizing the hydraulic fluid in the rear accumulator for use by hydraulic loads in the rear section.

11. The work machine of claim 10, wherein the hydraulic line is routed through the articulating connector.

12. The work machine of claim 1, further comprising a low voltage battery configured to provide low voltage direct current power to the work machine.

13. The work machine of claim 1, wherein the plurality of batteries of the power unit are mechanically separated into a first battery bank and a second battery bank.

14. A locally distributed electrical system for use in a work machine, comprising:
a first inverter installed on a front section of the work machine, the first inverter configured to convert a first portion of direct current electrical power provided by a power unit through a front power cable into alternating current to power:
a first front wheel assembly comprising a first front electrical motor configured to rotate a first front wheel shaft upon receiving the alternating current from the first inverter; and
a second front wheel assembly comprising a second front electrical motor configured to rotate a second front wheel shaft upon receiving the alternating current from the first inverter; and
a second inverter installed on a front section of the work machine, the second inverter configured to convert a second portion of the direct current electrical power provided by the power unit through a rear power cable into alternating current to power:
a first rear wheel assembly comprising a first rear electrical motor configured to rotate a first rear wheel shaft upon receiving the alternating current from the second inverter; and
a second rear wheel assembly comprising a second rear electrical motor configured to rotate a second rear wheel shaft upon receiving the alternating current from the second inverter, wherein the first front electrical motor, the second front electrical motor, the first rear electrical motor, and the second rear electrical motor are individually controlled.

15. The locally distributed electrical system of claim 14, further comprising a charging system to charge batteries of the power unit while the work machine is in motion, the charging system comprising:
a power conduit installed on the work machine, the power conduit configured to receive electrical power for charging the batteries;
a power source accessible electrically and mechanically by the power conduit of the work machine, wherein the power source provides the electrical power to the batteries of the power unit while the work machine is moving; and
a chopper inverter to convert the electrical power received from the power source through the power conduit to a second electrical power suitable for charging the batteries.

16. The locally distributed electrical system of claim 14, wherein:
the power unit is removably affixed in a first configuration, and wherein a plurality of batteries of the power unit are charged from power received through a charging port; and
the power unit is replaceable by a second power unit in a second configuration, wherein a secondary battery provides electrical power to the work machine while the power unit and the second power unit are electrically disconnected from the work machine.

17. The locally distributed electrical system of claim 14, further comprising a low voltage battery configured to provide low voltage direct current power to the work machine.

18. A locally distributed hydraulic system for use in a work machine, comprising:
a first hydraulic pump installed in a front section of the work machine, the first hydraulic pump configured to pump hydraulic fluid from a hydraulic tank into a front accumulator, pressurizing the hydraulic fluid in the front accumulator for use by hydraulic loads in the front section; and
a second hydraulic pump installed in a rear section of the work machine, the second hydraulic pump configured to pump the hydraulic fluid from the hydraulic tank, through a hydraulic line, and into a rear accumulator, pressurizing the hydraulic fluid in the rear accumulator for use by hydraulic loads in the rear section.

19. The locally distributed hydraulic system of claim 18, wherein the hydraulic line is routed through an articulating connector that that movably connects the front section to the rear section.

20. The locally distributed hydraulic system of claim 18, wherein:
the front accumulator is configured to raise and lower a lift mechanism installed in the front section to engage and disengage a power unit from the work machine; and
the rear accumulator is configured to raise and lower a bucket installed in the rear section, the bucket used to collect mined material.
